(19) United States
(12) Patent Application Publication
(10) Pub. No.: US 2016/0292385 A1
(43) Pub. Date: Oct. 6, 2016

(54) SYSTEMS AND METHODS FOR MEDICATION DOSAGE RANGE DETERMINATION AND VERIFICATION BASED ON PATIENT TEST RESULTS

(71) Applicant: MCKESSON CORPORATION, San Francisco, CA (US)

(72) Inventors: Christine Lekander, Cave Creek, AZ (US); Helen Welsh, Mesa, AZ (US); David A. Wunderlich, Gilbert, AZ (US)

(21) Appl. No.: 14/675,027

(22) Filed: Mar. 31, 2015

(51) Int. Cl. G06F 19/00

(52) U.S. Cl. CPC G06F 19/3456; G06F 19/322; G06F 19/328; G06F 19/345; G06F 19/366

(57) ABSTRACT

Systems and methods are provided for determining and verifying dosage levels for patient medications based on medical test results. Patient medical test results can be received and can include a patient identifier identifying the patient, a medical testing date identifying a date a medical test was administered to the patient, and medical test result data. Test result ranges can be identified for comparison to the medical test result data. The medical test result data can be compared to the test result ranges to determine which of the test result ranges the medical test result data falls within. Based on the determination, a medication dosage range associated with the test result range that the medical test result data falls within can be identified. The medication dosage range can be set as the determined and/or suggested medication dosage range for the particular medication for the patient.

### TECHNICAL FIELD

Aspects of the disclosure relate generally to determining a range of medication dosage to provide to a patient based on results of medical testing for the patient, and more particularly to systems and methods for determining a dosage range for a medication for a patient based on the test results of a patent and evaluating a healthcare transaction to determine if the dosage falls within the determined dosage range, as part of the processing of a healthcare transaction.

### BACKGROUND

Certain prescription medications carry risks and require healthcare providers to determine the appropriateness of certain therapies for a patient. In addition to patient education, sometimes, additional strategies are needed for ensuring safe and effective use by the patient. When these strategies are mandated by the Food & Drug Administration (FDA), they are known as Risk Evaluation and Mitigation Strategies (REMS). REMS programs outline the necessary elements needed to assure safe use.

Certain REMS programs require medical testing of the patient and monitoring of medical test results for the patient as a prerequisite to filling or refilling a prescription for the patient. For example, the drug clozapine requires that white blood cell (WBC) and absolute neutrophil count (ANC) be monitored at least monthly while a patient is taking clozapine. As another example, for a patient to take or continue taking the drug isotretinoin the patient may have to undergo monthly pregnancy testing. With all of the medical testing being received by the patient, at times, it can be difficult for the prescribing physician to recall exact test results and/or remember to modify the dosage amounts as test results for a patient change over time. It can also be difficult to determine based on a number of factors, how often the patient should be receiving medical testing. In addition, some medications have a time limit of a predetermined amount of days from the patient's medical test to the day the medication must be dispensed. Otherwise the patient must return to have the medical tests redone and the process restarted. This will cause delay in the ability for a patient to receive drug therapy, which may negatively affect patient health.

### BRIEF DESCRIPTION OF THE DRAWINGS

Reference will now be made to the accompanying drawings, which are not necessarily drawn to scale, and wherein:

FIG. 1 illustrates an example overview of a system that facilitates the determination and verification of dosage levels for prescribed medications to patients based on patient test results according to one exemplary embodiment.

FIG. 2A is a diagram of an example data flow for determining and verifying dosage levels for prescribed medications to patients or suggesting interruption or discontinuation of treatment with a medication based on patient test results according to one exemplary embodiment.

FIG. 2B is a diagram of another example data flow for determining and verifying dosage levels for prescribed medications to patients or suggesting interruption or discontinuation of treatment with a medication based on patient test results as part of the processing of laboratory and medical test data and healthcare transactions processed through one or more service providers according to an alternative exemplary embodiment.

FIGS. 3A and 3B are a flow chart of an example method for determining and verifying dosage levels for prescribed medications to patients based on patient test results, in accordance with one exemplary embodiment.

FIG. 4 is a flow chart of a method for determining a frequency for a patient to receive laboratory or medical testing based on patient test results, in accordance with one exemplary embodiment.

### DETAILED DESCRIPTION OF EXEMPLARY EMBODIMENTS

Exemplary embodiments will now be described more fully hereinafter with reference to the accompanying drawings, in which exemplary embodiments are shown. The concepts disclosed herein may, however, be embodied in many different forms and should not be construed as limited to the exemplary embodiments set forth herein; rather, these embodiments are provided so that this disclosure will be thorough and complete, and will fully convey the scope of the concepts to those skilled in the art. Like numbers refer to like, but not necessarily the same or identical, elements throughout.

Exemplary embodiments described herein include systems and methods that facilitate the determination of dosage ranges for prescribed medications to patients based on patient test results and verifying prescribed dosage levels for the patient fall within the determined dosage range provided in a healthcare transaction, such as a predetermination of benefits transaction, healthcare claim transaction, prescription claim or billing request, healthcare order transaction, or e-prescription transaction (e.g., electronic prescription order transaction, e-script, or e-prescription), in real-time, near real-time, or via batch processing.

For example, a patient can receive a lab or medical test (hereinafter referred to collectively as “medical test”). The laboratory, hospital, clinic, or other healthcare provider conducting the medical test can determine the medical test results and transmit them to the patient's physician or other prescriber of medication to the patient. In one example embodiment, the medical test results can be transmitted to the patient's physician via the service provider computer, which can receive the test results, conduct any evaluations of the test result data (e.g., including those described hereinbelow), store the test results in association with one or more identifiers for the patient, and forward the test results to the patient's physician.

The service provider computer can evaluate the test result data and determine, based at least in part upon that evaluation, a dosage range that is appropriate for the patient for a particular medication. The service provider computer can also evaluate the test result data as well as other data and determine, based at least in part upon the evaluation of the test result data and/or other data, the frequency at which the patient should receive the particular medical test. In one example, the test results data can be evaluated by the service provider computer to determine if the test results data fall within a normal range for the patient. The other data used in the evaluation can include, but is not limited to, the amount of time the patient has been taking the prescribed medication, whether the patient has had a gap in the receipt of medical tests that is larger than a threshold time gap, and/or threshold levels for test results data that, while considered normal, will increase suggested frequency of medical testing. The service provider computer can then notify the patient's physician of the test results, the determined dosage range for the medication, and the frequency that the patient should receive medical testing.

In certain examples, the patient's physician (or an approved designee of the physician) may provide a response to the service provider computer overriding one or more of the determined dosage and the determined frequency for medical testing for the patient. The override and the reasons for the override may be included in the response and stored by the service provider computer. The service provider computer may further update the determined dosage range and the determined frequency for medical testing based on the override.

The service provider computer may subsequently receive a healthcare transaction, such as a healthcare claim transaction, for a patient prescription from a pharmacy computer for a pharmacy. The healthcare claim transaction may include a patient identifier identifying the patient, a medication identifier identifying the medication prescribed to the patient, a dosage level for the prescribed medication as well as additional information, as discussed below. The service provider computer, based on the patient identifier, may retrieve the stored data for the patient and compare the determined dosage range (or dosage range based on a physician's (or approved designee of the physician's) override) to the dosage level in the healthcare transaction to determine if the dosage level falls within the determined dosage range. In one example, the service provider computer may forward on the healthcare transaction to a claims processor computer for a claims processor if the dosage level falls within the determined dosage range. On the other hand, the service provider computer may reject the healthcare transaction if the dosage level is outside of the determined dosage range for the prescribed medication and may transmit the rejected healthcare transaction response back to the pharmacy computer from which the healthcare transaction originated.

System Overview

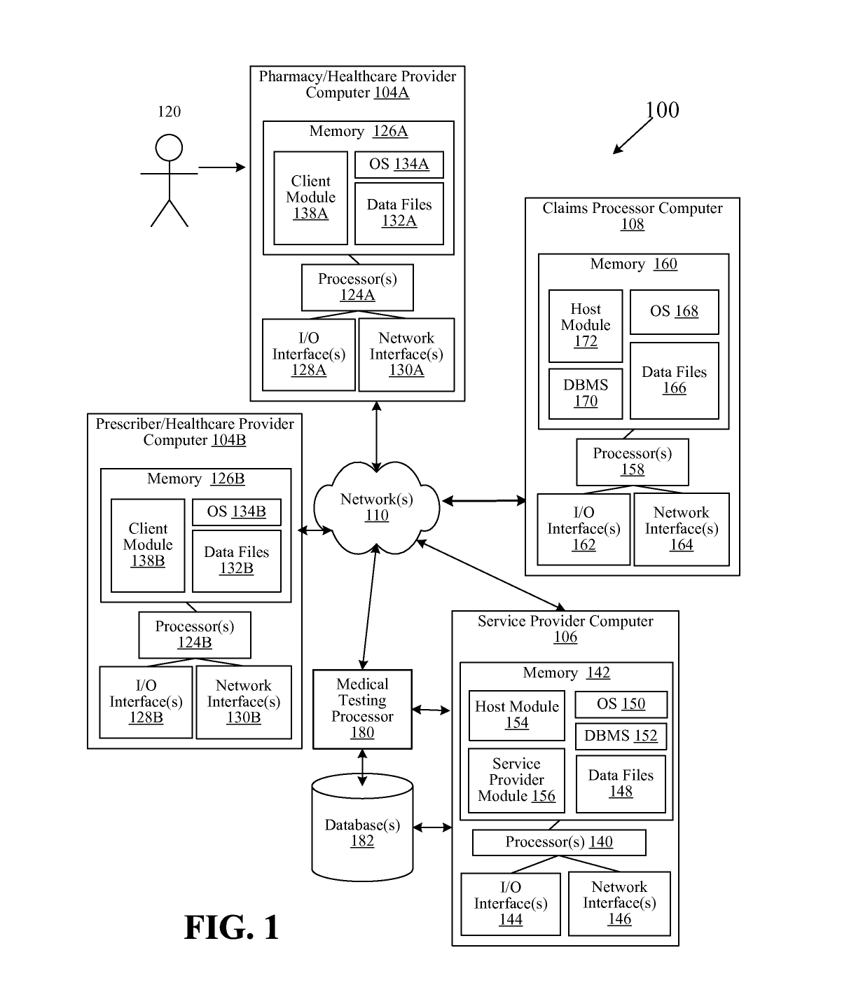

FIG. 1 illustrates an example system 100 supporting healthcare transactions, electronic prescription ordering activities, medical testing evaluation, and prescription billing activities according to one example embodiment. The exemplary system 100 facilitates the determination and verification of dosage levels for prescribed medications and medical testing frequency for a patient as part of or in-line with the processing of healthcare transactions and will now be described illustratively with respect to FIG. 1. As shown in FIG. 1, the system 100 may include at least one healthcare provider computer 104, at least one service provider computer 106, and at least one claims processor computer 108. In addition, in certain exemplary embodiments, the system 100 may include a medical testing processor 180. As shown in FIG. 1, multiple healthcare provider computers 104A and 104B are presented by way of example and may be referred to individually or collectively as “healthcare provider computer 104” hereinafter. Alternatively, each of the pharmacy/healthcare provider computer 104A and prescriber/healthcare provider computer 104B may be specifically discussed with reference to designations on FIG. 1.

As desired, each of the healthcare provider computers 104A and 104B, service provider computer 106, medical testing processor 180, and/or claims processor computer 108 may include one or more processing devices that may be configured for accessing and reading associated computer-readable media having stored thereon data and/or computer-executable instructions for implementing the various methods disclosed herein.

Additionally, in certain exemplary embodiments, the service provider computer 106 and prescriber/healthcare provider computer 104B may be in communication with one or more medical testing processors 180, which may access and/or be in communication with one or more suitable data storage devices, such as database 182. The medical testing processor 180 may receive patient and medical test information and data from the prescriber/healthcare provider computer 104B, one or more laboratories 280, clinics, hospitals, or other healthcare providers providing medical testing services to patients (not shown), the pharmacy/healthcare provider computer 104A, the patient 120, and/or the service provider computer 106. Upon receipt of the patient and medical test results data, the medical testing processor 180 may store test results data and a date the medical testing occurred in the database 182 and provide that or other data to the service provider computer 106 as necessary. Further, the medical testing processor 180 may evaluate the received test results data to determine a dosage range for a medication for the patient. Further, the medical testing processor 180 may also evaluate the received test results data as well as other medication and medical test history for the patient to determine a frequency at which the patient should receive medical testing. Alternatively, in certain exemplary embodiments, the system 100 may not include the medical testing processor 180 and instead, the service provider computer 106 may receive or facilitate the reception of patient and medical test information and data from the prescriber, prescriber/healthcare provider computer 104B, pharmacy/healthcare provider computer 104A, patient 120, and/or the individual laboratories 280, clinics, hospitals, or other healthcare providers, for storage in a data storage device, such as memory 142 or the database 182 and evaluation.

Generally, network devices and systems, including one or more of the healthcare provider computers 104A and 104B, service provider computer 106, medical testing processor 180, and claims processor computer 108 may include or otherwise be associated with suitable hardware and/or software for transmitting and receiving data and/or computer-executable instructions over one or more communications links or networks. These network devices and systems may also include any number of processors for processing data and executing computer-executable instructions, as well as other internal and peripheral components that are well known in the art. Further, these network devices and systems may include or be in communication with any number of suitable memory devices operable to store data and/or computer-executable instructions. By executing computer-executable instructions, each of the network devices may form a special purpose computer or particular machine. As used herein, the term “computer-readable medium” describes any form of suitable memory or memory device.

As shown in FIG. 1, the healthcare provider computers 104A and 104B, service provider computer 106, claims processor computer 108, and medical testing processor 180 may be in communication with each other via one or more networks, such as network 110, which as described below can include one or more separate or shared private and public networks, including the Internet or a publicly switched telephone network. Each of these components—the healthcare provider computers 104A and 104B, service provider computer 106, claims processor computer 108, medical testing processor 180, and the network 110 will now be discussed in further detail.

Each healthcare provider computer 104 may be associated with (e.g., located within or otherwise providing computing services for) a healthcare provider, such as, for example, a prescriber (such as a doctor, dentist, nurse practitioner, physician's assistant, hospital, physician's office, urgent care center or any other person legally permitted to prescribe medication to a patient) or pharmacy, etc. While the exemplary healthcare provider computers 104A and 104B reference a pharmacy (104A) and a prescriber of medication (104B) this is for example only and is not intended to be limiting in any manner. Each healthcare provider computer 104A and 104B may be any suitable processor-driven device that facilitates the processing of healthcare requests made by patients or consumers and the communication of information associated with medical testing and/or healthcare transactions to the service provider computer 106, such as a server computer, a mainframe computer, one or more networked computers, a desktop computer, a personal computer, a digital assistant, a personal digital assistant, a digital tablet, an Internet appliance, an application-specific circuit, microcontroller, minicomputer, or any other processor-based device. In certain example embodiments, each healthcare provider computer 104A and 104B may be a suitable point of sale device associated with (e.g., located at) a healthcare provider. The execution of the computer-implemented instructions by either healthcare provider computer 104A and 104B may form a special purpose computer or other particular machine that is operable to facilitate the evaluation and processing of medical test data and the processing of healthcare requests made by patients, prescribers and/or pharmacies and the communication of information associated with healthcare transactions to a service provider computer 106. Additionally, in certain exemplary embodiments, the operations and/or control of each healthcare provider computer 104A and 104B may be distributed amongst several processing components in the same or different locations.

In addition to each having one or more processors 124A and 124B, each healthcare provider computer 104A and 104B may include one or more memory devices 126A and 126B, one or more input/output (“I/O”) interfaces 128A and 128B, and one or more network interfaces 130A and 130B. The memory devices 126A and 126B may be any suitable memory device, for example, caches, read-only memory devices, random access memory devices, magnetic storage devices, removable storage devices, etc. The memory devices 126A and 126B may store data, executable instructions, and/or various program modules utilized by each healthcare provider computer 104A and 104B, for example, data files 132A and 132B, an operating system (“OS”) 134A and 134B, and/or a client module 138A and 138B, respectively. Each of the data files 132A and 132B may include any suitable data that facilitates the receipt and/or processing of medical test data and healthcare requests by the respective healthcare provider computer 104A and 104B and the generation and/or processing of healthcare transactions that are communicated to the service provider computer 106. For example, the data files 132A and 132B may include, but are not limited to, healthcare information and/or contact information associated with one or more patients, information associated with the particular healthcare provider and/or the respective healthcare provider computer 104A and 104B, information associated with the service provider computer 106, information associated with one or more claims processors, and/or information associated with one or more healthcare transactions. The OS 134A and 134B may be any suitable software module that controls the general operation of the respective healthcare provider computer 104A and 104B. The OS 134A and 134B may also facilitate the execution of other software modules by the one or more respective processors 124A and 124B, for example, the client module 138A and 138B. Each of the OS 134A and 134B may be, but is not limited to, Microsoft Windows®, Apple OSX™, Linux, Unix, or a mainframe operating system.

Each client module 138A and 138B may be an Internet browser or other suitable software, including a dedicated program, for interacting with the service provider computer 106. For example, a user 120 such as a pharmacist, pharmacy assistant, nurse practitioner, physician, nurse, physician's assistance, or other pharmacy, hospital or physician's office employee or any other persons associated with a prescriber, pharmacy, or healthcare provider may utilize the respective client module 138A and 138B in preparing and providing a healthcare transaction, such as a healthcare claim transaction, prescription claim or billing request, healthcare order transaction, or e-prescription transaction (e.g., electronic prescription order transaction, e-script, or e-prescription), to the service provider computer 106 for delivery to the appropriate claims processor computer 108 or other third-party for adjudication or other coverage/benefits determination. Each healthcare provider computer 104A and 104B may also utilize the respective client module 138A and 138B to retrieve or otherwise receive data, messages, or responses from the service provider computer 106 and/or other components of the system 100. For example, in certain embodiments, the client module 138A and 138B may be utilized to receive a medical test results, rejections of the healthcare transaction and/or an adjudicated response to healthcare transactions from the service provider computer 106 as will be described below.

The one or more I/O interfaces 128A and 128B may facilitate communication between the respective healthcare provider computer 104A and 104B and one or more input/output devices, for example, one or more user interface devices, such as, a display, keypad, mouse, keyboard, control panel, touch screen display, remote control, microphone, etc. that facilitate user interaction with the particular healthcare provider computer 104A and 104B. For example, the one or more I/O interfaces 128A and 128B may facilitate entry of information associated with a healthcare transaction by an employee 120 of a healthcare provider, such as a pharmacy employee, pharmacist, physician, nurse, physician's assistant, hospital employee, or nurse practitioner affiliated with a pharmacy, hospital, physician's office or other similar healthcare provider. The one or more network interfaces 130A and 130B may facilitate connection of the particular healthcare provider computer 104A and 104B to one or more suitable networks, for example, the network 110 illustrated in FIG. 1. In this regard, each healthcare provider computer 104A and 104B may receive and/or communicate information to other network components of the system 100, such as the service provider computer 106.

With continued reference to FIG. 1, the service provider computer 106 may include, but is not limited to, any suitable processor-driven device that is configured for receiving, processing, and fulfilling information and/or requests from the healthcare provider computers 104A and 104B, the medical testing processor 180, and/or the claims processor computer 108 relating to medical testing, pharmacy, benefits, billing, electronic prescription submission, and/or other healthcare transactions and/or other activities. In certain exemplary embodiments, the service provider computer 106 may be a switch/router that receives and routes medical test results that include medical test data for a patient, healthcare transactions and/or other healthcare requests. For example, the service provider computer 106 may route healthcare claim transactions communicated from one of the healthcare provider computers 104A and 104B to a claims processor computer 108, such as a pharmacy benefits manager (PBM), an insurer, a Medicare payor, or other third-party payor. In another example, the service provider computer 106 may receive medical test results for a patient from a laboratory 280, hospital, clinic, or other healthcare provider conducting the medical testing on the patient 120 and may route the medical test results to one or both of the healthcare provider computers 104A and 104B.

In certain example embodiments, the service provider computer 106 may include a suitable host server, host module, or other software that facilitates the receipt of medical test results from a laboratory 280, hospital, clinic, or other healthcare provider conducting medical testing on the patient 120, the receipt of a healthcare transaction from a healthcare provider computer 104A or 104B and/or the routing of the received medical test results to a healthcare provider computer 104A or 104B and/or healthcare transactions to a claims processor computer 108. Any number of healthcare provider computers 104A and 104B, medical testing processors 180, and/or claims processor computers 108 may be in communication with the service provider computer 106 as desired in various embodiments.

The service provider computer 106 may include any number of special purpose computers or other particular machines, application-specific circuits, microcontrollers, personal computers, minicomputers, mainframe computers, servers, networked computers, and/or other processor-driven devices. In certain example embodiments, the operations of the service provider computer 106 may be controlled by computer-executed or computer-implemented instructions that are executed by one or more processors associated with the service provider computer 106 to form a special purpose computer or other particular machine that is operable to facilitate the receipt, routing, and/or processing of medical test results and/or healthcare transactions. The one or more processors that control the operations of the service provider computer 106 may be incorporated into the service provider computer 106 and/or in communication with the service provider computer 106 via one or more suitable networks. In certain exemplary embodiments, the operations and/or control of the service provider computer 106 may be distributed amongst several processing components.

Similar to the healthcare provider computers 104A and 104B described above, the service provider computer 106 may include one or more processors 140, one or more memory devices 142, one or more input/output (“I/O”) interfaces 144, and one or more network interfaces 146. The one or more memory devices 142 may be any suitable memory devices, for example, caches, read-only memory devices, random access memory devices, magnetic storage devices, removable memory devices, etc. The one or more memory devices 142 may store data, executable instructions, and/or various program modules utilized by the service provider computer 106, for example, data files 148, an operating system (“OS”) 150, the host module 154, a service provider module 156, and a database management system (“DBMS”) 152 to facilitate management of data files 148 and other data stored in the memory devices 142. The OS 150 may be any currently existing or future-developed operating system including, but not limited to, Microsoft Windows®, Apple OSX™, Linux, Unix, or a mainframe operating system. The OS 150 may be a suitable software module that controls the general operation of the service provider computer 106 and/or that facilitates the execution of other software modules.

The service provider module 156 may be operable to perform one or more pre-edits or pre-analysis, including, but not limited to an analysis of medical testing results related to a patient, a determination of proper dosage ranges for medication based at least in part on the medical testing results data, a determination of frequency of which the patient should receive medical testing, based at least in part on an evaluation of the medical test results data, and/or an evaluation of a dosage level in the received healthcare transaction and a determination as to whether the dosage level is within a determined dosage range prior to routing or otherwise communicating the received healthcare transaction, such as a healthcare claim transaction, to a suitable claims processor computer 108. Additionally, the service provider module 156 may be operable to perform one or more post-edits on an adjudicated reply or response that is received from a claims processor computer 108 for a healthcare transaction prior to routing the adjudicated response to one of the healthcare provider computers 104A and 104B. A wide variety of different pre-edits and/or post-edits may be performed as desired in various embodiments of the invention.

According to one exemplary embodiment, the data files 148 may store healthcare transaction records associated with communications received from various healthcare provider computers 104A and 104B, various laboratories, hospitals, clinics, or other healthcare providers conducting the medical tests on patients, and/or various claims processor computers 108. The data files 148 may also store any number of suitable routing tables that facilitate determining the destination of communications received from a laboratory 280, hospital, clinic, or other healthcare provider conducting the medical tests, the healthcare provider computer 104A and 104B or claims processor computer 108. The data files 148 may further store patient and medical testing data, baselines, parameters, qualifications, length of time a patient has been prescribed a particular medication (or similarly the start date for the patient being prescribed the medication), lower and upper threshold time periods, a threshold time gap for not receiving medical testing, two or more test level frequencies, medical testing history for the patient (including dates that the patient received medical testing, the type of medical testing conducted, and the medical test results data for each medical test), as well as tables, lists, and/or schedules that identify which medications are associated with which laboratory tests or REMS programs, associations of medical test results data to recommended dosage ranges for the medication in the particular REMS program based on the medical test results data, identifications of ranges or amounts for what qualifies as normal medical test results data, associations between the length of time a patient has been prescribed a medication and the frequency that the patient should be receiving medical tests, the parameters to compare lab testing results against, and/or the one or more time periods, if any, within which the healthcare transaction must be processed after the medical testing is complete.

The host module 154 may receive, process, and respond to requests from the client module 138 of one of the healthcare provider computers 104A and 104B, a computer associated with a laboratory 280, hospital, clinic, or other healthcare provider conducting the medical tests, and/or may further receive, process, and respond to requests of the host module 172 of the claims processor computer 108. The service provider computer 106 may include additional program modules for performing other processing methods described herein. Those of ordinary skill in the art will appreciate that the service provider computer 106 may include alternate and/or additional components, hardware or software without departing from exemplary embodiments of the invention.

With continued reference to the service provider computer 106, the one or more I/O interfaces 144 may facilitate communication between the service provider computer 106 and one or more input/output devices, for example, one or more user interface devices, such as a display, mouse, keyboard, keypad, control panel, touch screen display, remote control, microphone, etc. that facilitate user interaction with the service provider computer 106. The one or more network interfaces 146 may facilitate connection of the service provider computer 106 to one or more suitable networks, for example, the network 110 illustrated in FIG. 1. In this regard, the service provider computer 106 may communicate with other components of the system 100.

The medical testing processor 180 of FIG. 1 represents one or more repositories, computers, or other processor-driven devices that can be in one location or remotely distributed in different geographic locations. Each medical testing processor 180 may include computer-executable instructions for receiving and processing patient and medical testing information and data. The patient and medical testing information and data can be received by the medical testing processor 180 from a computer associated with (e.g., located within or providing computing services for) a laboratory 280, hospital, clinic, or other healthcare provider conducting the medical tests; from the prescriber, such as via the prescriber/healthcare provider computer 104B; from a pharmacist, such as via the pharmacy/healthcare provider computer 104A; from the patient 120, such as via a patient computer; from the service provider computer 106, and/or from a third-party entity that collects, such as directly from the labs 280 conducting the testing, and provides medical testing results and data related to patients that have received a medical test. In certain exemplary embodiments, the medical testing processor 180 can receive patient and medical testing information and data from labs 280 providing lab testing services via, for example, the network 110 and can store that information in one or more databases 182 associated with each medical testing processor 180. Alternatively, the information may be received via conventional mail, phone, fax, email, text message, batch processing, or the like and entered into the processor 180 for storage in the database 182. In one example, the patient and medical testing information can include patient and medical testing data, baselines, parameters, qualifications, length of time a patient has been prescribed a particular medication (or similarly the start data for the patient being prescribed the medication), lower and upper threshold time periods, a threshold time gap for not receiving medical testing, two or more test level frequencies, medical testing history for the patient (including dates that the patient received medical testing, the type of medical testing conducted, and the medical test results data for each medical test), as well as tables, lists, and/or schedules that identify which medications are associated with which medical tests or REMS programs, associations of medical test results data to recommended dosage ranges for the medication in the particular REMS program based on the medical test results data, identifications of ranges or amounts for what qualifies as normal and ideal medical test results data and what qualifies as normal but not ideal medical test results data, associations between the length of time a patient has been prescribed a medication and the frequency that the patient should be receiving medical tests, the parameters to compare lab testing results against, and/or the one or more time periods, if any, within which the healthcare transaction must be processed after the medical testing is complete.

As desired, each medical testing processor 180 may include any number of special purpose computers or other particular machines, application-specific circuits, microcontrollers, personal computers, minicomputers, mainframe computers, servers, and the like. In certain exemplary embodiments, the operations of the medical testing processor 180 may be controlled by computer-executed or computer-implemented instructions that are executed by one or more processors associated with each particular medical testing processor 180 to form a special purpose computer or other particular machine that is operable to facilitate the receipt, processing, and/or storage of patient and medical testing information and data received from the laboratory 280, hospital, clinic, or other healthcare provider conducting the medical tests, the prescriber/healthcare provider computer 104B, the pharmacy/healthcare provider computer 104A, and/or the service provider computer 106. The one or more processors that control the operations of each particular medical testing processor 180 may be incorporated into the medical testing processor 180 and/or in communication with the medical testing processor 180 via one or more suitable networks, such as network 110. In certain example embodiments, the operations and/or control of each particular medical testing processor 180 may be distributed amongst several processing components.

Similar to other components of the system 100, each medical testing processor 180 may include one or more processors, one or more memory devices, one or more I/O interfaces, and one or more network interfaces. The one or more memory devices may be any suitable memory devices, for example, caches, read-only memory devices, random access memory devices, magnetic storage devices, removable memory devices, etc. The one or more memory devices may store data, executable instructions, and/or various program modules utilized by the medical testing processor 180, for example, data files, an OS, a DBMS, and a host module. The data files may include any suitable information that is utilized by each particular medical testing processor 180 to receive, process, analyze, and/or store patient and medical testing results data. The OS 168 may be a suitable software module that controls the general operation of the particular medical testing processor 180. The OS may also facilitate the execution of other software modules by the one or more processors, for example, the DBMS and/or the host module. The OS may be any currently existing or future-developed OS including, but not limited to, Microsoft Windows®, Apple OSX™, Linux, Unix, or a mainframe operating system. The DBMS may be a suitable software module that facilitates access and management of one or more databases, such as database 182, that is utilized to store information that is received by or utilized by the medical testing processor 180. The host module may initiate, receive, process, analyze, store, and/or respond to requests, such as the receipt of patient and medical testing information and data. The medical testing processor 180 may include additional program modules as desired. Those of ordinary skill in the art will appreciate that the medical testing processor 180 may include alternate and/or additional components, hardware or software without departing from example embodiments disclosed herein.

The one or more I/O interfaces may facilitate communication between the medical testing processor 180 and one or more input/output devices, for example, one or more user interface devices, such as a display, mouse, keyboard, keypad, control panel, touch screen display, remote control, microphone, etc. that facilitate user interaction with the medical testing processor 180. The one or more network interfaces may facilitate connection of each particular medical testing processor 180 to one or more suitable networks, for example, the network 110 illustrated in FIG. 1. In this regard, the medical testing processor 180 may receive patient and medical testing information and data and/or other communications from a laboratory 280, hospital, clinic, or other healthcare provider conducting the medical tests, the prescriber/healthcare provider computer 104B, the pharmacy/healthcare provider computer 104A, the patient 120, and/or service provider computer 106.

The databases 182 may be operable to store information associated with various patients and/or various medical tests conducted on patients, including, but not limited to, patient and medical testing data, baselines, parameters, qualifications, length of time a patient has been prescribed a particular medication (or similarly the start data for the patient being prescribed the medication), lower and upper threshold time periods, a threshold time gap for not receiving medical testing, two or more test level frequencies, medical testing history for the patient (including dates that the patient received medical testing, the type of medical testing conducted, and the medical test results data for each medical test), as well as tables, lists, and/or schedules that identify which medications are associated with which laboratory tests or REMS programs, associates of medical test results data to recommended dosage ranges for the medication in the particular REMS program based on the medical test results data, identifications of ranges or amounts for what qualifies as normal medical test results data, associations between the length of time a patient has been prescribed a medication and the frequency that the patient should be receiving medical tests, the parameters to compare lab testing results against, and/or the one or more time periods, if any, within which the healthcare transaction must be processed after the medical testing is complete. The patient and medical testing information and data in the database 182 may then be accessed and evaluated by the medical testing processor 180 and/or the service provider computer 106.

With continued reference to FIG. 1, the claims processor computer 108 may be any suitable processor-driven device that facilitates receiving, processing, and/or fulfilling healthcare transactions, such as healthcare claim transactions, prescription claim or billing requests, healthcare order transactions, or e-prescription transactions (e.g., electronic prescription order transactions, e-scripts, or e-prescriptions) received from the service provider computer 106. For example, the claims processor computer 108 may be a processor-driven device associated with a pharmacy benefits manager (PBM), an insurer, a government payor, or a claims clearinghouse. As desired, the claims processor computer 108 may include any number of special purpose computers or other particular machines, application-specific circuits, microcontrollers, personal computers, minicomputers, mainframe computers, servers, and the like.

In certain exemplary embodiments, the operations of the claims processor computer 108 may be controlled by computer-executed or computer-implemented instructions that are executed by one or more processors associated with the claims processor computer 108 to form a special purpose computer or other particular machine that is operable to facilitate the receipt, processing, and/or fulfillment of healthcare transaction requests received from the service provider computer 106. The one or more processors that control the operations of the claims processor computer 108 may be incorporated into the claims processor computer 108 and/or in communication with the claims processor computer 108 via one or more suitable networks. In certain embodiments, the operations and/or control of the claims processor computer 108 may be distributed amongst several processing components.

Similar to other components of the system 100, the claims processor computer 108 may include one or more processors 158, one or more memory devices 160, one or more input/output (“I/O”) interfaces 162, and one or more network interfaces 164. The one or more memory devices 160 may be any suitable memory devices, for example, caches, read-only memory devices, random access memory devices, magnetic storage devices, removable memory devices. The one or more memory devices 160 may store data, executable instructions, and/or various program modules utilized by the claims processor computer 108, for example, data files 166, an operating system (“OS”) 168, a database management system (“DBMS”) 170, and a host module 172. The data files 166 may include any suitable information that is utilized by the claims processor computer 108 to process healthcare transactions, for example, patient profiles, patient insurance information, other information associated with a patient, information associated with a healthcare provider, etc. The operating system (OS) 168 may be a suitable software module that controls the general operation of the claims processor computer 108. The OS 168 may also facilitate the execution of other software modules by the one or more processors 158, for example, the DBMS 170 and/or the host module 172. The OS 168 may be any currently existing or future-developed operating system including, but is not limited to, Microsoft Windows®, Apple OSX™, Linux, Unix, or a mainframe operating system.

The DBMS 170 may be a suitable software module that facilitates access and management of one or more databases that are utilized to store information that is utilized by the claims processor computer 108 in various embodiments of the invention. The host module 172 may initiate, receive, process, and/or respond to requests, such as healthcare transactions or claim requests, from the host module 154 of the service provider 106. The claims processor computer 108 may include additional program modules for performing other pre-processing or post-processing methods described herein. Those of ordinary skill in the art will appreciate that the claims processor 108 computer may include alternate and/or additional components, hardware or software without departing from the example embodiments described herein.

The one or more I/O interfaces 162 may facilitate communication between the claims processor computer 108 and one or more input/output devices, for example, one or more user interface devices, such as a display, mouse, keyboard, keypad, control panel, touch screen display, remote control, microphone, etc. that facilitate user interaction with the claims processor computer 108. The one or more network interfaces 164 may facilitate connection of the claims processor computer 108 to one or more suitable networks, for example, the network 110. In this regard, the claims processor computer 108 may receive healthcare transactions and/or other communications from the service provider computer 106 and the claims processor computer 108 may communicate information associated with processing the healthcare transactions to the service provider computer 106.

The network 110 may include any telecommunication and/or data network, whether public, private, or a combination thereof, including a local area network, a wide area network, an intranet, the Internet, intermediate hand-held data transfer devices, and/or any combination thereof and may be wired and/or wireless. The network 110 may also allow for real-time, off-line, and/or batch transactions to be transmitted between or among the healthcare provider computers 104A and 104B, the service provider computer 106, medical testing processor 180, a laboratory 280, hospital, clinic, or other healthcare provider conducting the medical tests, and/or the claims processor computer 108. Due to network connectivity, various methodologies, as described herein may be practiced in the context of distributed computing environments. Although the service provider computer 106 is shown for simplicity as being in communication with the healthcare provider computers 104A and 104B, the medical testing processor 180, or the claims processor computer 108 via one intervening network 110, it is to be understood that any other network configuration is possible. For example, intervening network 110 may include a plurality of networks, each with devices such as gateways and routers for providing connectivity between or among networks 110. Instead of, or in addition to, a network 110, dedicated communication links may be used to connect the various devices in accordance with an example embodiment. For example, the service provider computer 106 may form the basis of network 110 that interconnects one or more of the healthcare provider computers 104A and 104B, the medical testing processor 180, a laboratory 280, hospital, clinic, or other healthcare provider conducting the medical tests, and the claims processor computer 108.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. For example, in one exemplary embodiment, the service provider computer 106 (or other computer) may be implemented as a specialized processing machine that includes hardware and/or software for performing the methods described herein. In addition, at least a portion of the processor and/or processing capabilities of the service provider computer 106 may be implemented as part of the pharmacy computer 104A, prescriber computer 104B, medical test processor 180, or claims processor computer 108. Accordingly, the exemplary embodiments described herein should not be construed as being limited to any particular operating environment, system architecture, or device configuration.

Operational Overview

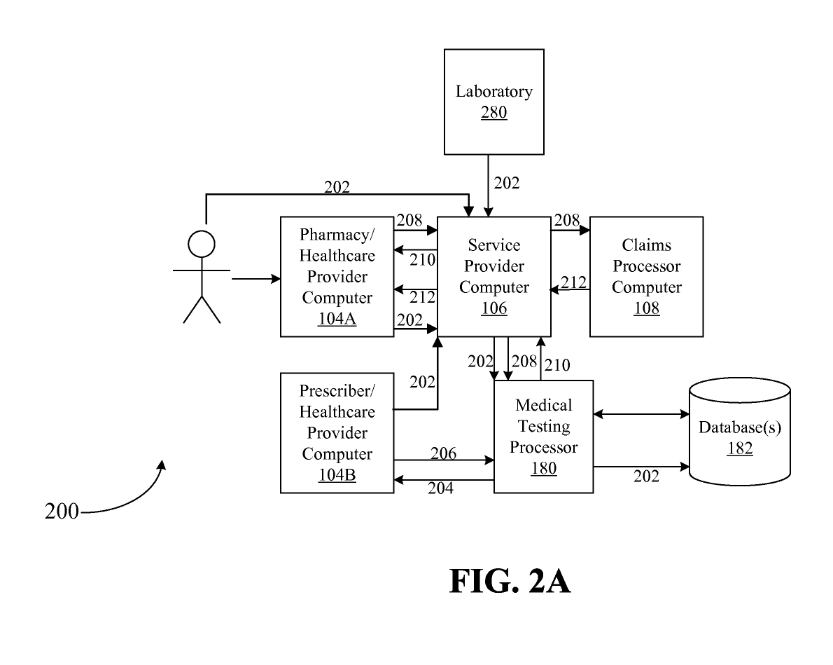

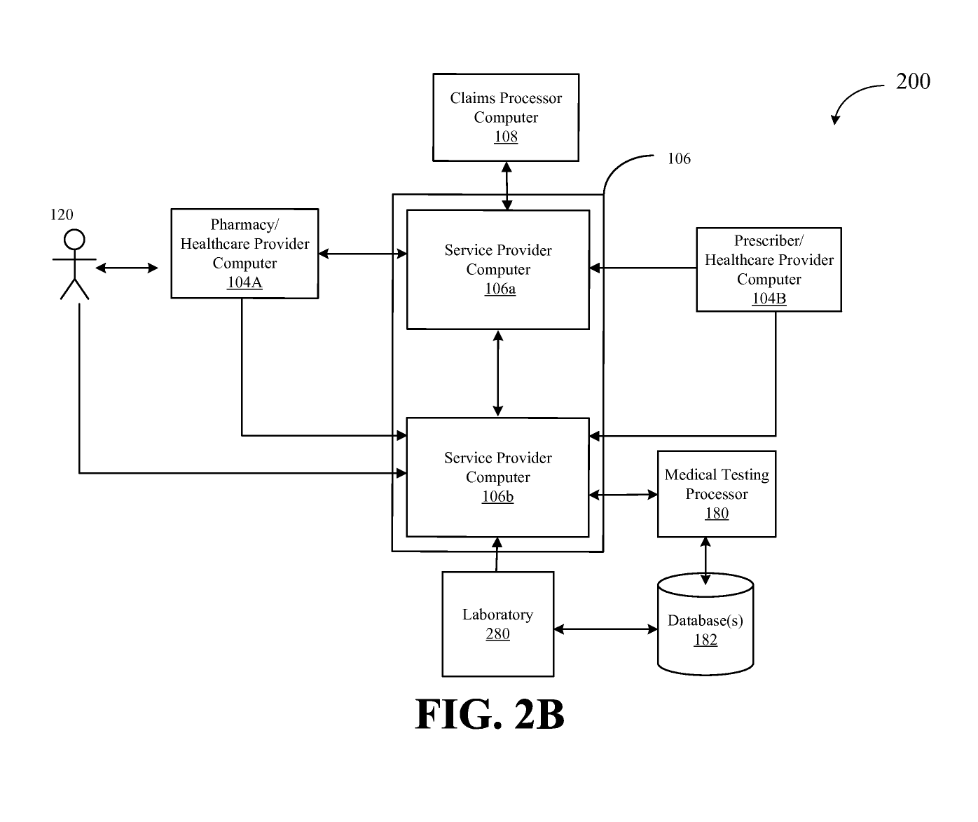

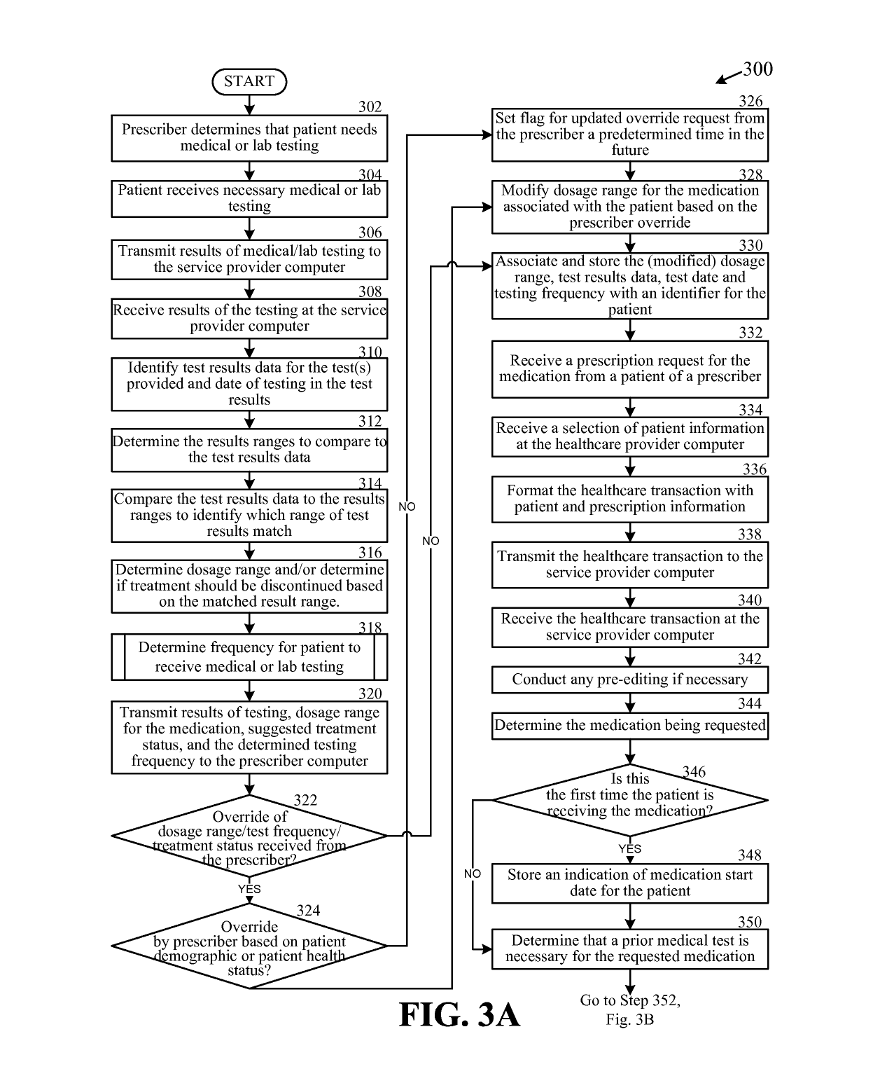

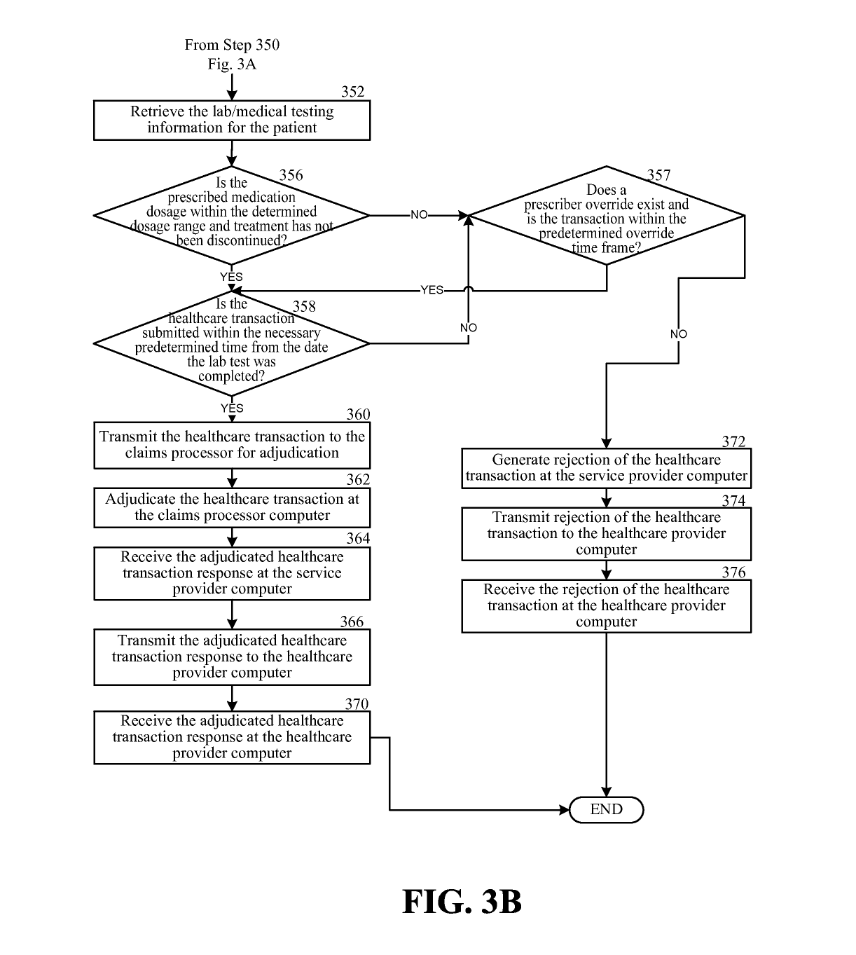

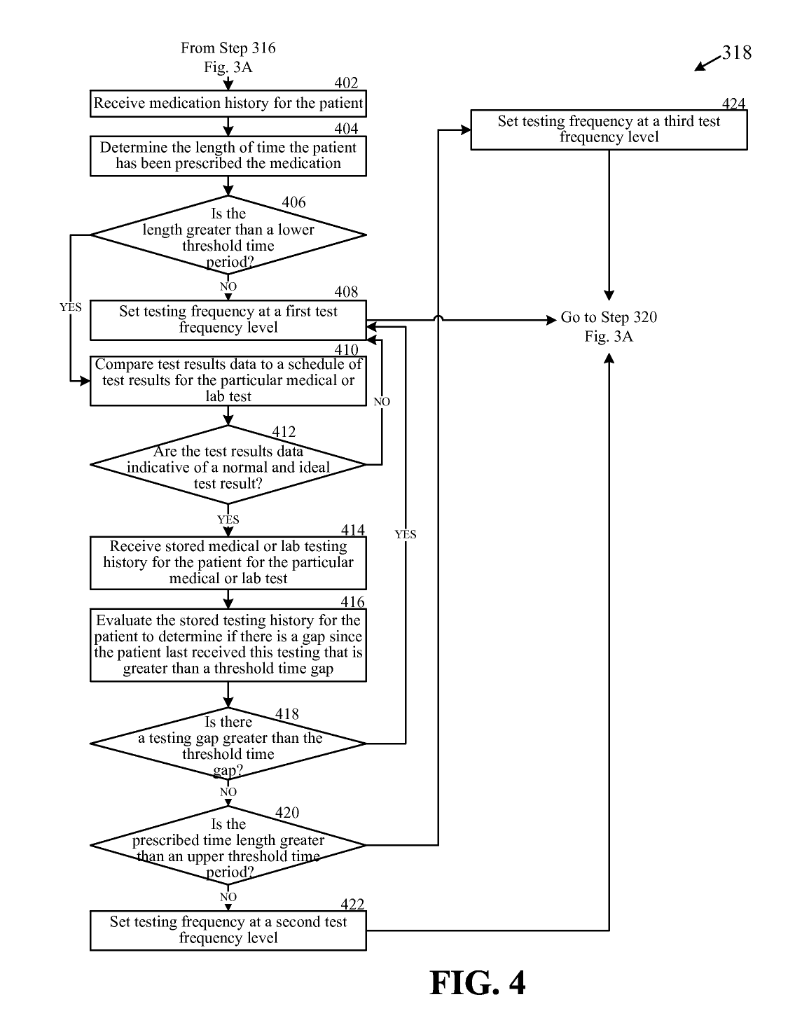

FIG. 2A is a diagram of one example data flow 200 for determining and verifying dosage levels for prescribed medications to patients or suggesting interruption or discontinuation of treatment with a medication based on patient test results as part of or in-line with the processing of a healthcare transaction (e.g., a predetermination of benefits transaction, a healthcare claim transaction, prescription claim or billing request, healthcare order transaction, or e-prescription transaction (e.g., electronic prescription order transaction, e-script, or e-prescription)) through a service provider, such as through the service provider computer 106 illustrated in FIG. 1. FIGS. 3A and 3B are a flow chart of an example method 300 for determining and verifying dosage levels for prescribed medications to patients based on patient test results, in accordance with one example embodiment. All or a portion of the steps in the exemplary method 300, described below, may be performed by a suitable service provider computer 106 and/or medical testing processor 180.

The exemplary method 300 will be described with reference to a prescriber (e.g., physician (or an approved designee of the physician), nurse, nurse practitioner, physician's assistant, hospital, or any other person legally permitted to prescribe medications to patients) as one healthcare provider (and accordingly a prescriber computer as the first healthcare provider computer 104B) and a pharmacy as another healthcare provider (and accordingly a pharmacy computer as another healthcare provider computer 104A). However, this is only for purposes of example as other healthcare providers could be substituted for, and should each be individually read as being a part of this method. As such, where the discussion of the methods below and the drawings state a prescriber and/or a pharmacy, any other healthcare provider could be substituted, such as a physician, hospital, physician's office, clinic, or healthcare center.

In addition, the exemplary method 300 will be described with reference to a healthcare claim transaction; however, this also is only for purposes of example as other healthcare transactions, which may include, for example, a predetermination of benefits transaction, the healthcare claim transaction, prescription claim or billing request, healthcare order transaction, or e-prescription transaction (e.g., electronic prescription order transaction, e-script, or e-prescription) could be substituted for the healthcare claim transaction and each form of healthcare transaction should each individually be read as being used in the method described below.

Referring now to FIGS. 1, 2A, 3A and 3B, the exemplary method 300 begins at the START step proceeds to step 302, where a prescriber, such as a physician (or an approved designee of the physician), determines that a patient needs medical testing and an evaluation of the medical test results before a medication may be dispensed to or refilled for the patient. In one example embodiment, the medication for the patient is one that is distributed under a prescription safety network program, such as a REMS program. In certain example embodiments, the requirements of the prescription safety network program must be satisfied prior to receiving, prescribing, or dispensing the medication under that particular REMS program. For example, in order to satisfy the requirements of the prescription safety network program prior to receiving, prescribing, or dispensing the medications or products under the program the patient may be required to receive medical testing and the results data from that medical testing may need to be evaluated.

In step 304, the patient receives the necessary medical testing. The patient may either receive the testing at the same facility as the physician or may attend an unrelated medical facility to complete the medical testing. For example, the medical testing may occur at a laboratory 280, hospital, clinic, or facility of another healthcare provider. Alternatively, the testing may occur at the same location as the prescriber or at a pharmacy. The medical test results 202 may be transmitted or otherwise provided by the party conducting the medical testing, by the physician (via the prescriber computer 104B or other communication methods), by the patient 120 (via a compute or other communication methods), or by the pharmacy (via the pharmacy computer 104A or other communication methods) to the service provider computer 106 in step 306. In one example embodiment, a computer associated with a laboratory 280, hospital clinic, or other facility conducting the medical testing or reviewing the medical testing may transmit the medical test results 202 to the service provider computer 106 via the network 110. Alternatively, the medical test results 202 may be sent to the service provider via short message service (SMS) message, email, facsimile, phone, interactive voice recognition system, a website, via traditional mailing techniques, or other known methods of communication and entered into the service provider computer 106. In another example embodiment, the medical test results 202 may be entered into the prescriber computer 104B (e.g., by the prescriber), pharmacy computer 104A (e.g., by the pharmacist), or in another computer by the patient, and transmitted to the database 182 via the service provider computer 106 and/or the medical testing processor 180 over the network 110.

In step 308, the medical test results 202 are received at the service provider computer 106. As discussed above, the service provider computer may store the results 202 in the database 182 or transmit the results 202 to the medical testing processor 180 for storage in the database 182. In one example embodiment, the medical test results 202 include one or more patient identifiers (e.g., patient first name, patient last name, social security number, health insurance claim number (HICN), patient address (e.g., street address, city, state, and/or zip code) or other unique identifier of the patient), medical test result data for the patient, and a date that the medical testing was conducted. According to one example embodiment, the medical test results 202 may be formatted in accordance with a version of the Health Level 7 (HL7) Standard, although other standards, such as National Council for Prescription Drug Programs (NCPDP) Telecommunication Standard, ANSI ASC X-12 Standard, or NCPDP Script Standard, proprietary format standards, and non-standard formats may be utilized as well.

In step 310, the medical testing processor 180 or another portion of the service provider computer 106 can identify the medical test results data and testing date in the medical test results 202. In one example, the medical testing processor 180 can parse the medical test results 202 to identify the date the testing was conducted and the medical test results data for the patient for the one or more medical tests conducted on the patient. In step 312, the medical testing processor 180 or another portion of the service provider computer 106 can determine the group of potential test result categories to compare to the medical test results data. In one example, each of the one or more groups of potential test result categories can include a set of test result ranges to compare to the medical test results data for the patient to for a particular medication. For example, the medical testing processor 180 can evaluate the received medical test results and can determine which prescription safety network program is associated with the medical testing provided to the patient. Based on the determination of the prescription safety network program, the medical testing processor 180 can determine the medication under that program and stored test result ranges (and associated dosage ranges for that medication). In alternative embodiments, the medical test results 202 may contain an identifier for the prescription safety network program and/or the medication to be prescribed to the patient and the medical testing processor 180 or another portion of the service provider computer 106 may identify the potential test result categories (e.g., the group of ranges of potential test results) for the medical testing provided to the patient based on this information.

In step 314, the medical testing processor 180 or another portion of the service provider computer 106 can compare the medical test results data for the patient to the determined ranges of potential test result categories. In one example, the comparison is made to identify the particular range (or outcome) of potential test results that the patient's medical test results data is within or otherwise equates to. In one example embodiment, the ranges of potential test result categories are a table or schedule of ranges of potential test results having an upper bound and a lower bound. Alternatively, the ranges of potential test result categories are a table or schedule of potential outcomes of test results, such as, for example, positive, negative, yes, no, or a range of test results where the upper bound and lower bound are the same. Each of the ranges identified in each of the potential test result categories or outcomes can have a corresponding or associated medication dosage range that should be prescribed to the patient and/or an indication that the treatment with the medication should be discontinued or interrupted for a period of time based on the patient's medical test results data. For example, if a patient received a blood glucose test, the ranges of potential test results could be blood glucose level ranges of 70-85; 86-100; 101-115; and over 115. For each of these ranges of potential test results, the table or record for that range may include or be associated with a particular dosage range for the medication (in this case insulin) or an indication that the use of insulin should be discontinued or interrupted for a period of time for the patient. If the medical test result data for the patient indicated a blood glucose level of 91, the medical testing processor 180 could determine that the result is within the 86-100 blood glucose level range.

The medical testing processor 180 or another portion of the service provider computer 106 can determine the dosage range for the medication to be prescribed and/or determine if treatment should be discontinued based on the medical test results data and the identified range of potential test results that the test results data falls within or matches in step 316. For example, the medical testing processor 180 could identify the dosage range associated with the matching potential test result range (e.g., identify the insulin dosage range in the matching record for the 86-100 blood glucose level range). In step 318, the medical testing processor 180 or another portion of the service provider computer 106 may determine the frequency at which the patient should be receiving this medical test. In one example embodiment, the determination can be based at least in part on the medical test result data for the patient from this most recent medical test. In addition, the determination can be made based at least in part on the length of time the patient has been prescribed the particular medication and whether the patient has had a gap in receiving medical testing recently that exceeds a threshold time gap. The determination will be described in greater detail below with respect to FIG. 4.

In step 320, the medical testing processor 180 or another portion of the service provider computer 106 can transmit a notification 204 to the prescriber computer 104B for the patient's physician (e.g., the prescriber) via the network 110 that includes the medical test results, the determined dosage range for the medication to be prescribed to the patient, the suggested treatment status (e.g., should the treatment continue, be discontinued, or be interrupted for a period of time), and/or the determined frequency to receive the medical test for the patient. Alternatively, the notification 204 may be sent to the prescriber via SMS message, email, facsimile, phone, interactive voice recognition system, a website, via traditional mailing techniques, or other known methods of communication.

In step 322, an inquiry is conducted to determine if an override of the determined dosage, medical test frequency, and/or treatment status for the patient is received from the prescriber (or an approved designee of the prescriber) via the prescriber computer 104B at the medical testing processor 180 or another portion of the service provider computer 106 via the network 110. Alternatively, the override may be sent to the service provider via SMS message, email, facsimile, phone, interactive voice recognition system, a website, via traditional mailing techniques, or other known methods of communication. In one example embodiment, the determination can be made by the medical testing processor 180 or another portion of the service provider computer 106. For example, after receiving the notification 204, the prescriber (or an approved designee of the prescriber) can transmit a response 206 to the notification 204 that includes an override message or code. The prescriber can override one or more of the dosage, medical test frequency, and the treatment status. The response 206 can be transmitted from the prescriber computer 104B to the medical testing processor 180 via the network 110. Alternatively, the response 206 may be sent to the service provider and/or medical testing processor 180 via SMS message, email, facsimile, phone, interactive voice recognition system, a website, via traditional mailing techniques, or other known methods of communication. In one example, the response 206 may include a rationale provided by the prescriber for overriding one or more of the determined dosage range for the medication, determined medical test frequency, and determined treatment status for the patient. The rationale can be in the form of a code (alphanumeric) or provided in a free text field. In one example, the rationale for overriding the determined medication dosage range, determined medical test frequency, and/or determined treatment status can include, but is not limited to, the reason that the medical test results data is reflective of other issues occurring with the patient's health or the benefits of overriding the determined dosage range and prescribing a dosage level that is outside of that range outweighs the potential risks. Other potential reasons for issuing the override is that the patient is in a particular demographic category (e.g., age, gender, race, etc.) or the status of the patient's health is such that the determined dosage range, determined medical test frequency, and/or determined treatment status may not be suitable. In one example embodiment, the response 206 may also include an override time frame that represents the length of time that the override should continue without having to submit an additional response containing another override or an update to the current override. In certain example embodiments, if an override is received for the determined dosage range, the recommended dosage level in the override response 206 will replace the determined dosage range. Similarly, if an override is received for the determined medical test frequency, the frequency provided in the override response 206 will replace the determined medical test frequency. Likewise, if an override is received for the determined treatment status, the treatment status provided in the override response 206 will replace the determined treatment status. If an override response 206 is not received by the service provider computer 106 and/or the medical testing processor 180, the NO branch is followed to step 330. Alternatively, the YES branch is followed to step 324.

In step 324, an inquiry is conducted to determine if the override in the response 206 was made by the prescriber based on one or more demographics of the patient and/or based on the health status (e.g., concomitant therapy issues or other health concerns of the patient that are the basis for issuing the override) of the patient. The determination can be made by the medical testing processor 180 or another portion of the service provider computer 106. For example, the medical testing processor 180 can evaluate a rationale included in the override response 206 to determine the basis for the prescriber issuing an override of one or more of the determined dosage range for the prescribed medication, the determined medical test frequency for the patient, and/or the treatment status for the patient. If the override was not made by the prescriber due to a demographic of the patient and/or the health status of the patient, the NO branch is followed to step 328. Otherwise, the YES branch is followed to step 326.

In step 326, the medical testing processor 180 or another portion of the service provider computer 106 can set a flag or reminder associated with a record for the patient in the database 182 to request an update from the prescriber for the patient, whose name or identifier can also be stored in a record for the patient, a certain amount of time in the future. In one example, the amount of time is six months. However, the time period is adjustable and can be any amount of time between 1-3000 days. In certain example embodiments, it may be necessary to get a re-verification from the prescriber that the prior override should continue in force. In step 328, the determined dosage range and/or determined medical test frequency is modified based on the override response 206 submitted by the prescriber (e.g., via the prescriber computer 104B). In one example, the modification can be made by the medical testing processor 180 or another portion of the service provider computer 106.

The medical testing processor 180 or another portion of the service provider computer 106 can associate the determined dosage range for the medication, the determined medical test frequency (or the modified one or both based on a received override response 206), the medical test results date, and the medical test results data with one or more patient identifiers (e.g., patient first name, patient last name, patient address (e.g. street address, city, state, and/or zip code), patient date of birth, patient gender, social security number, and/or HICN) and can store it in a record for the patient in the database 182.

In step 332, a pharmacist at a pharmacy receives a prescription request from a patient. The prescription is typically received by the patient from the physician or other prescriber of the medication, such as a doctor, dentist, nurse, or physician's assistant or any other person legally permitted to prescribe medication to a patient. The patient may go to the location of the pharmacy and physically hand the prescription request to the pharmacist or make a request via a web portal communicably coupled to the pharmacy computer 104A or an IVR communicably coupled to the pharmacy computer 104A. In an alternative embodiment, an e-prescription is electronically transmitted from the prescriber computer 104B to the pharmacy computer 104A via the network 110. In certain exemplary embodiments, this e-prescription may pass through the service provider computer 106 on its way from the prescriber computer 104B to the pharmacy computer 104A. The pharmacist determines the patient's name and accesses the pharmacy computer 104A, which receives a selection of patient information from the pharmacist via the I/O interface 128A in step 334. For example, the pharmacist accesses the pharmacy computer 104A and accesses a database of patient information, which may be stored in memory 126A or in another database either local or remote from the pharmacy computer 104A. The pharmacist can then select the name or other patient identification information in the patient information database that matches the name or other identification information of the patient.

In step 336, a healthcare claim transaction 208 is generated and/or formatted at the pharmacy computer 104A. In certain exemplary embodiments, the pharmacy computer 104A formats the healthcare claim transaction 208 with patient information (e.g., patient identifiers), Payor ID/routing information (e.g., claims processor/destination identifiers), and medication/product information (e.g., medication/product identifiers). The information can be input into the healthcare claim transaction 208 by the pharmacist via the I/O interface 128A or automatically retrieved and entered by the pharmacy computer 104A and, in certain situations, can be based at least in part on historical transaction information for the patient in the data files 132A or a database communicably coupled to the pharmacy computer 104A. According to one example embodiment, the healthcare claim transaction 208 may be formatted in accordance with a version of the National Council for Prescription Drug Programs (NCPDP) Telecommunication Standard, although other standards, such as ANSI ASC X-12 Standard, Health Level 7 (HL7) Standard, or NCPDP Script Standard may be utilized as well.

The healthcare claim transaction 208 may include a Banking Identification Number (BIN Number), a BIN Number and Processor Control Number (PCN), or a BIN Number and Group ID for identifying a particular claims processor computer (e.g., accountable care organization, PBM, payor, healthcare insurance company, Medicare or other government healthcare insurance payor, Medicare Part D provider, etc.), such as the claims processor computer 108, as a destination for the healthcare claim transaction 208. In addition, the healthcare claim transaction 208 may also include information relating to the patient, payor, prescriber, healthcare provider, and/or the requested product/medication. As an example, the healthcare claim transaction 208 may include one or more of the following information:

Payor ID/Routing Information (Destination Identifier)
BIN Number, BIN Number and PCN and/or BIN Number and Group ID, that designates a destination of a healthcare claim transaction 208

Patient Identifying Information
Name (e.g. Patient Last Name, Patient First Name, etc.)
Date of Birth of Patient
Age of Patient
Gender of Patient
Patient Address (e.g. Street Address, City, State, Zip/Postal Code, etc.)
Patient Contact Information (e.g. Patient Telephone Number, Email Address, etc.)
Patient Health Condition Information
Patient ID or other identifier (e.g., Health Insurance Claim Number (HICN), Social Security Number, etc.)

Insurance/Coverage Information
Cardholder Name (e.g. Cardholder First Name, Cardholder Last Name)
Cardholder ID and/or other identifier (e.g. Person Code)
Group ID and/or Group Information

Prescriber Information
Primary Care Provider ID or other identifier (e.g. NPI code)
Primary Care Provider Name (e.g. Last Name, First Name)
Prescriber ID or other identifier (e.g. NPI code, DEA number)
Prescriber Name (e.g. Last Name, First Name)
Prescriber Contact Information (e.g. Telephone Number, Email Address, Fax Number, etc.)
Pharmacy or other Healthcare Provider Information (e.g. Store Name, Chain Identifier, etc.)
Pharmacy or other Healthcare Provider ID (e.g. NPI code)

Claim Information
Drug, service, or product identifier (e.g. National Drug Code (NDC) code, RxNorm code, drug name, drug formulation, etc.)
Prescription/Service Reference Number
Date Prescription Written
Quantity Dispensed
Dosage
Days' Supply
Diagnosis/Condition (e.g., Diagnosis Code (e.g., International Statistical Classification of Diseases and Related Health Problems (ICD) Diagnosis Code)
Pricing information for the drug/service/product (e.g. Network Price, Usual & Customary price)
Number of Refills Authorized
One or more NCPDP Message Fields
One or more Drug Utilization (DUR) Codes
Date of Service.

The healthcare claim transaction 208 can be used to determine if the claims processor associated with the claims processor computer 108 approves or rejects payment coverage for the product or medication being requested in the healthcare claim transaction 208 and, if approved, the amount the claims processor will cover (or pay) for the product or medication being prescribed and how much the patient co-pay amount will be.

The pharmacy computer 104A transmits the healthcare claim transaction 208 to the service provider computer 106 in step 338. In step 340, the service provider computer 106 receives the healthcare claim transaction 208. For example, the healthcare claim transaction 208 can be transmitted by the pharmacy computer 104A to the service provider computer 106 through the network 110. In step 342, the service provider computer 106 conducts any pre-editing, if necessary, on the healthcare claim transaction 208. The pre-edits may include verifying, adding, and/or editing information included in the healthcare claim transaction 208 prior to it being communicated to a claims processor computer 108. For example, the service provider computer 106 can parse the healthcare claim transaction 208, to determine if the Patient ZIP/Postal Zone was submitted and if it is valid. In example embodiments where the medical testing processor 180 is separate from the service provider computer 106, the service provider computer 106 may forward the healthcare claim transaction 208 or all or a portion of the data therein to the medical testing processor 180.

In step 344, the medical testing processor 180 or another portion of the service provider computer 106 determines the medication being requested in the healthcare claim transaction 208. In one exemplary embodiment, the medical testing processor 180 parses the healthcare claim transaction 208 and evaluates the field in the transaction 208 associated with the prescribed medication to determine the name or code, for example an NDC number, in that field. In step 346, an inquiry is conducted to determine if the patient is receiving this medication for the first time. In one example embodiment, the determination can be made by the medical testing processor 180 or another portion of the service provider computer 106. For example, the medical testing processor 180 can identify one or more stored records for the patient based on a match of one or more patient identifiers in the healthcare claim transaction 208 to one or more corresponding patient identifiers in a multitude of patient records in the database 182. The medical testing processor 180 may then compare the NDC number or other medication identifier from the healthcare claim transaction 208 to the matching stored historical medication records for the patient in the database 182 to determine if a record or an entry in a single record includes a medication identifier that matches the medication identifier from the healthcare claim transaction 208 and denotes that the patient has previously received the medication. If the determination is that the patient has received the medication previously, the NO branch is followed to step 350. On the other hand, if this is the first time the patient is receiving this medication, the YES branch is followed to step 348.

In step 348, the medical testing processor 180 or another portion of the service provider 106 can store an indication (e.g., a date) of the current date (the medication start date) in a historical medication record for the patient in the database 182. A determination is made that completion of a lab test is necessary before the medication may be dispensed to the patient in step 350. In one exemplary embodiment, the determination is made by the medical testing processor 180 or another portion of the service provider computer 106. In this exemplary embodiment, the medical testing processor may compare the NDC number or another medication identifier for the requested medication and parsed from the healthcare claim transaction against a listing, schedule, or table of medications for which one or more prior medical tests are needed by the patient. Alternatively, the medical testing processor 180 may look up information by the NDC number or other medication identifier associated with the requested medication and in that table identify information that notifies that a prior medical test is needed for the medication to be dispensed and/or refilled. The listing, table, and/or schedule may be located in the data files 148 and or the database 182 and may be accessed directly by the medical testing processor 180.

In step 352, the medical test results for the patient identified in the healthcare claim transaction 208 is retrieved or otherwise accessed. In one example embodiment, the medical test results are retrieved by the medical testing processor 180 or another portion of the service provider computer 106. For example, the medical testing processor 180 may parse the healthcare claim transaction to determine one or more of the patient identifiers (e.g., first name, last name, date of birth, gender, address (e.g., street address, city, state, and/or zip code) contact information, health condition information, social security number, or HICN). The identified patient information may then be compared to a table, listing, or schedule in the database 182 of medical test results for patients to determine if a patient match exists. The medical test results in the database 182 may include any one or all of, but are not limited to, any of the Patient Information, the medical test (for example by NDC number), date the medical test was conducted on the patient, and the medical test results data for the patient. The medical testing processor 180 or another portion of the service provider computer 106 may retrieve the medical test results associated with the matching patient from the database 182.

In step 356, an inquiry is conducted to determine if the dosage listed in the healthcare claim transaction 208 is within the dosage range determined in step 316 and that the medication treatment has not been discontinued for the patient. In one example embodiment, the determination can be made by the medical testing processor 180 or another portion of the service provider computer 106. For example, the medical testing processor 180 can parse the healthcare claim transaction 208 and retrieve the dosage amount from the predetermined field of the transaction 208. The medical testing processor 180 can then compare the dosage amount from the transaction 208 to the determined dosage range or treatment status (e.g., discontinue or interrupt for a period of time) to determine if the dosage amount is within the determined dosage range and that treatment is not being discontinued or interrupted. For example, if the determined dosage range (or the override dosage range provided by the prescriber) is 17-20 units and the dosage amount is 18 units, then the prescribed dosage amount would be within the determined dosage range. Conversely, if the determined dosage range is 17-20 units and the prescribed dosage amount is 22 units, then the prescribed dosage amount would not be within the determined dosage range. In another example, if the dosage amount is 18 units and the treatment status is to discontinue treatment, then the dosage amount would not be within the determined dosage range. If the prescribed dosage amount is not within the determined dosage range (or the override dosage range provided by the prescriber) or the treatment has been discontinued or interrupted, then the NO branch is followed to step 357. Otherwise the YES branch is followed to step 358.

In step 357, an inquiry is conducted to determine if a prescriber override exists for the patient and if the healthcare claim transaction 208 was submitted within the predetermined override time frame. In one example, embodiment, the determination can be made by the medical testing processor 180 or another portion of the service provider computer 106. For example, the medical testing processor 180 can query the database 182 to determine if a prescriber override has been stored for the patient identified in the healthcare claim transaction 208. If a prescriber override is identified in the database 182, the medical testing processor can compare the date of service for the healthcare claim transaction 208 to the date of the override and the predetermined override time frame to determine if the date of service falls within an active period of the prescriber override. For example, if the date of the prescriber override is Jan. 15, 2015, and the predetermined override time frame (e.g., received from the prescriber as part of the override response 206) is 90 days, a healthcare claim transaction 208 having a date of service of Mar. 19, 2015, would fall within the active period of the prescriber override while a healthcare claim transaction 208 having a date of service of Jun. 11, 2015, would not fall within the active period of the prescriber override. If a prescriber override exists for the patient for the particular treatment and the healthcare claim transaction 208 was submitted within the predetermined override time frame, the YES branch is followed to step 358. Otherwise, the NO branch is followed to step 372.

In step 358, an inquiry is conducted to determine if the healthcare claim transaction 208 was received within a predetermined period of time from the date the medical test was completed. In one example embodiment, the determination can be made by the medical testing processor 180 or another portion of the service provider computer 106. For certain medications, the time period between a patient receiving a medical test and the medication being dispensed to the patient may not exceed a predetermined number of days. This may be referred to as a medical test time limit. In one example embodiment, the medical test time limit, if any, is provided in a table, schedule, or listing and associated with the particular medication, such as by NDC number or other medication identifier, in the data files 148 and/or the database 182. Examples of medical test time limits include any time period between one day-one year including, but not limited to, one week, two weeks, one month, or three months. For example, the medical testing processor 180 can parse the healthcare claim transaction 208 to determine the date of service (i.e., the date the transaction 208 was submitted) and can compare the date of service to the date the patient received the medical test, the medical test completion date, to determine the number of days between the date of service and the medical test completion date. The medical testing processor 180 may then compare that number of days to the medical test time limit, if any, for the medication requested to determine if the number of days is less than or equal to the medical test time limit. If the number of days is greater than the medical test time limit, the NO branch is followed to step 357.

In step 372, the medical testing processor 180 or another portion of the service provider computer 106 can generate a rejection 210 of the healthcare claim transaction. The service provider computer 106 transmits the rejection 210 to the pharmacy computer 104A via the network 110 in step 374. The pharmacy computer 104A receives the rejection 210 of the healthcare claim transaction for a dosage level outside the determined dosage level range and/or submission of a healthcare claim transaction 208 at a date that was too long after the medical test received by the patient in step 376. The rejection 210 may include text that identifies the reason for the rejection, including a dosage level outside the determined dosage level range and/or submission of a healthcare claim transaction 208 at a date that was too long after the medical test received by the patient to allow for dispensing of the medication. The process then continues to the END step.

Returning to the inquiry of step 358, if the number of days is less than or equal to the medical test time limit, the YES branch is followed to step 360. The service provider computer 106 transmits the healthcare claim transaction 208 to the claims processor computer 108 for adjudication in step 360. For example, a healthcare claim transaction 208 can be transmitted from the service provider computer 106 to the claims processor computer 108 via the network 110. The claims processor computer 108 receives and adjudicates the healthcare claim transaction 208 in step 362 to determine if the patient has coverage for the requested medication, to what extent the patient's coverage covers the requested medication identified in the transaction 208, and the patient co-pay, if any. Example adjudications can include, but are not limited to, accepted, approved, paid, denied, or denied with request for additional information and resubmission. In certain example embodiments, the adjudication can be input into a field of the healthcare claim transaction 208 that is recognized by the service provider computer 106 and/or the pharmacy computer 104A. In step 364, the claims processor computer 108 transmits the adjudicated healthcare claim transaction response 212 to and it is received by the service provider computer 106 via, for example, the network 110.

In step 366, the service provider computer 106 transmits the adjudicated healthcare claim transaction response 212 to the pharmacy computer 104A. In one example embodiment, the adjudication healthcare claim transaction response 212 is transmitted to the pharmacy computer 104A via the network 110. Alternatively, the adjudication healthcare claim transaction response 212 may be transmitted to a pharmacy via SMS message, email, facsimile, phone, interactive voice recognition system, a website, via traditional mailing techniques, or other known methods of communication. The adjudicated healthcare claim transaction response 212 is received by the pharmacy computer 104A in step 370. If the transaction was approved and the parties agree to the financial requirements set forth in the response 212, the pharmacy may dispense the medication to the patient. If the transaction was denied, the pharmacy may inform the patient of the denial and the basis for the denial included in the adjudicated healthcare claim transaction response 212. The process then continues to the END step.

FIG. 4 is a flow chart of an example method 318 for determining a frequency for a patient to receive laboratory or medical testing based at least in part on medical test results data for a patient, in accordance with one exemplary embodiment of the disclosure. Now referring to FIGS. 1, 2A, 3A, and 4, the exemplary method 318 begins at step 402, where the medical testing processor 180 or another portion of the service provider computer 106 receives the medication history for the patient identified in the healthcare claim transaction 208. In one example, the medication history may be received from the database 182 or data files 148. The medication history includes one or more patient identifiers, one or more medication identifiers for a medication prescribed to the patient and medication initiation date representing the first day the patient was dispensed that particular medication. In one example embodiment, the medical testing processor can identify one or more stored records for the patient based on a match of one or more patient identifiers in the healthcare claim transaction 208 to one or more corresponding patient identifiers in a multitude of patient records in the database 182. The medical testing processor 180 may then compare the NDC number or other medication identifier from the healthcare claim transaction 208 to the matching stored historical medication records for the patient in the database 182 to determine dates when the patient was prescribed/dispensed the medication. The earliest of those dates can be identified as the medication initiation date.

The medical testing processor 180 or another portion of the service provider computer 106 can determine the length of time the patient has been prescribed the particular medication in step 404. For example, the medical testing processor 180 can calculate the difference between the current date and the medication initiation date to identify the length of time the patient has been prescribed the medication. In step 406 an inquiry is conducted to determine if the length of time that the patient has been prescribed the medication is greater than a lower threshold time period. In certain example embodiments, the determination can be made by the medical testing processor 180 or another portion of the service provider computer 106. For example, the medical testing processor 180 can compare the determined length of time in step 404 to the lower threshold time period retrieved from the database 182 or the data files 148. The lower threshold time period can be a configurable amount of time that may be the same or different for different medications. The lower threshold time period can represent the minimum amount of time that the patient has been prescribed the drug before the patient is able to reduce the frequency of medical testing below the most frequent level. In one example, the lower threshold time period is six months and the most frequent medical testing level is medical testing every week for the patient. If the length of time the patient has been prescribed the medication is greater than or equal to the lower threshold time period, then the YES branch is followed to step 410. If the length of time that the patient has been prescribed the medication is less than the lower threshold time period, then the NO branch is followed to step 408.

In step 408, the determined medical test frequency is set to the first test frequency level by the medical testing processor 180 or another portion of the service provider computer 106. The process then continues to step 320 of FIG. 3A. In step 410, the medical testing processor 180 or another portion of the service provider computer 106 can compare the medical test results data for the patient to a schedule of test results data for the particular medical test to determine if the medical test results data for the patient is indicative of a normal and ideal test result or a normal but not ideal test result. In one example embodiment, the normal and ideal test result is a range of results having an upper bound and a lower bound and the patient's medical test results data is normal if it is between or within the upper bound and lower bound of that range. Further, normal but not ideal test result determinations may be another range of results (having potentially a second upper bound and second lower bound for one range and a third upper bound and third lower bound for a second range) that is above the upper bound (e.g., the second upper bound and second lower bound) or below the lower bound (e.g., the third upper bound and third lower bound) of the normal range. As with the determination of normal and ideal, the patient's medical test results data may be determined to be normal but not ideal if it is within one of the range of results identified as normal but not ideal for the particular treatment. In step 412, an inquiry is conducted to determine if the medical test results data for the patient is indicative of a normal and ideal test result (e.g., as opposed to a normal but not ideal test result). In one example, the determination can be made by the medical testing processor 180 or another portion of the service provider computer and can be based at least in part on the comparison of the patient's medical test results data to the normal and ideal test result or normal and ideal range of test results and the normal but not ideal range of test results, which can be stored in the database 182. If the patient's medical test results data are within one of the ranges for normal but not ideal test results, then the NO branch will be followed back to step 408. For example, if the patient's test results are not within the ideal range for test results, the patient will have to continue receiving medical testing at the most frequent rate (e.g., weekly). If the patient's medical test results data are indicative of a normal test result (e.g., the results data is within the normal and ideal range of test results or matches a normal and ideal level/outcome) then the YES branch will be followed to step 414.

In step 414, the medical testing processor 180 or another portion of the service provider computer 106 can receive a stored history of medical test results for the patient. In one example, the history of medical test results can be stored in and received from the database 182 and/or the data files 148. In step 416, the medical testing processor 180 or another portion of the service provider computer 106 can evaluate the stored history of medical test results for the patient to determine if there is an unauthorized gap in medical testing since the patient last received this medical testing and if that unauthorized gap is greater than a threshold time gap. In one example, the determination can be made by the medical testing processor 180 or another portion of the service provider computer 106. For example, the medical testing processor 180 can receive the threshold time gap parameter from the database 182 or data files 148 and can compare it to any identified unauthorized gap to see if the unauthorized gap is greater than the threshold time gap. For example, if the patient is supposed to have medical tests weekly, but prior to the most recent test, it had been three weeks since the patient had a medical test, then the unauthorized gap would be three weeks. If the threshold time gap was two weeks the patient would have violated it but if the threshold time gap was four weeks, then the threshold would not be violated. The threshold time gap is configurable and can be any amount between 1 day-2 years. In one example embodiment, the threshold time gap is one month.

In step 418, an inquiry is conducted to determine if there is an unauthorized gap in medical testing for the patient that is greater than the threshold time gap. In one example, the determination is made by the medical testing processor 180 or another portion of the service provider computer 160. If the unauthorized gap in medical testing is greater than the threshold time gap, then the YES branch is followed back to step 408. In this example, if the patient violates the threshold by not receiving medical testing during that length of time, the frequency of medical testing for the patient will be determined to be the most frequent testing level (e.g., one week). If the unauthorized gap in medical testing is not greater than the threshold time gap, then the NO branch is followed to step 420.

In step 420, an inquiry is conducted to determine if the length of time that the patient has been prescribed the medication is greater than an upper threshold time period. In certain example embodiments, the determination can be made by the medical testing processor 180 or another portion of the service provider computer 106. For example, the medical testing processor 180 can compare the determined length of time in step 404 to the upper threshold time period retrieved from the database 182 or the data files 148. The upper threshold time period can be a configurable amount of time that may be the same or different for different medications. The upper threshold time period can represent the minimum amount of time that the patient has to have been prescribed the drug before the patient is able to be scheduled for medical testing at the least frequent period of time. In one example, the upper threshold time period is one year and the least frequent medical testing period is medical testing every four weeks for the patient. If the length of time the patient has been prescribed the medication is less than the upper threshold time period, then the NO branch is followed to step 422, where the determined medical test frequency is set at a second test frequency level, which is less than the first test frequency level. In one example, the second test frequency level is a medical test frequency of every two weeks, however, other timer periods are available as the amount is configurable. The process then proceeds to step 320 of FIG. 3A. Returning to step 420, if the length of time that the patient has been prescribed the medication is greater than or equal to the upper threshold time period, then the YES branch is followed to step 424, where the determined medical test frequency is set at a third test frequency level, which is less than both the first and second test frequency levels. In one example, the third test frequency level is equal to the least frequent medical testing period for the medication. In the example above, the least frequent period was four weeks. The process then continues to step 320 of FIG. 3A.

The methods described and shown in FIGS. 3A-4 may be carried out or performed in any suitable order as desired in various embodiments. Additionally, in certain exemplary embodiments, at least a portion of the operations may be carried out in parallel. Furthermore, in certain exemplary embodiments, less than or more than the operations described in FIGS. 3A-4 may be performed.

Likewise, while FIGS. 3A-4 have been described primarily in conjunction with FIG. 2A, it will be appreciated that variations of FIG. 2A are available. As shown in FIG. 2B, the service provider computer 106 may include two or more distinct service provider computers 106a and 106b that are in communication with each other. These distinct service provider computers 106a and 106b may be owned, operated, and/or located by the same or distinct and wholly-unrelated companies. The service provider computer 106a may be operative with the pharmacy computer 104A, prescriber computer 104B, and the claims processor computer 108, while the service provider computer 106b may be operative with laboratories 280 or other medical testing providers, pharmacy computer 104A, prescriber computer 104B, patient 120 other healthcare provider computers and/or other third-party entity computers. In certain example embodiments, the service provider computer 106b may be configured to receive medical test results from laboratories 280 or other medical test providers, the pharmacy computer 104A, the prescriber computer 104B, the patient 120 (e.g., via a patient computer) and may further be configured to determine medication dosage ranges, medical test frequency, and/or whether treatment should be discontinued based at least in part on the medical test result data for the patient. The service provider computer 106b may be further configured to store the determined medication dosage ranges, medical test frequency, and the determination as to whether the treatment should be discontinued in a database for access by the service provider computer 106a or optionally transmit the determined medication dosage ranges, medical test frequency, and/or the determination as to whether the treatment should be discontinued to the service provider computer 106a.

The service provider computer 106a may be configured to receive a healthcare transaction, such as a healthcare claim transaction, from the pharmacy computer 104A. The service provider computer 106a may be further configured to evaluate the healthcare claim transaction to determine if the prescribed dosage for the medication identified in the healthcare claim transaction is within the determined medication dosage range determined by the service provider computer 106b. If the prescribed dosage is within the determined medication dosage range, the service provider computer 106a may be configured to transmit the healthcare claim transaction to the claims processor computer 108 for adjudication. On the other hand, if the prescribed dosage is not within the determined medication dosage range, the service provider computer 106a may be configured to generate a rejection of the healthcare claim transaction and transmit the rejection to the pharmacy computer from which the healthcare claim transaction originated. Under the arrangement, the service provider computer 106a may be permitted to utilize or offer the medication dosage range and test frequency determination services based on the medical test results data for patients provided by the service provider computer 106b, including the operation and use of the medical testing processor 180 and/or the database 182 to conduct the determinations of the medication dosage ranges and the medical test frequencies based on an evaluation of medical test results and/or historical records for a patient, as discussed above in FIGS. 3A-4. Accordingly, the services accessible by the service provider computer 106b, including the medication dosage range and test frequency determination services, may be available to the pharmacy computer 104A and/or the prescriber computer 104B via the service provider computers 106a and 106b.

Accordingly, example embodiments disclosed herein can provide the technical effects of creating a system and methods that provide a real-time or near real time way to determine if treatment should be discontinued for a patient, determine and verify dosage levels for a prescribed medication, and/or determine medical test frequencies for a patient based at least in part on an evaluation of medical test results data for a patient. In this regard, pharmacists and prescribers of medications will be able to ensure whether a patient should continue a treatment regimen for a medication, ensure proper dosages are being prescribed to patients and ensure medical testing for patients receiving medication under a prescription safety network program are receiving medical testing at the correct frequency. This can lead to a better determination of the proper dosage for patients, leading to overall better healthcare outcomes. It can also lead to a more controlled and quantifiable medical testing schedule that will also help ensure better overall healthcare outcomes for the patients.

While certain example embodiments disclosed herein describe the medical testing processor 180 as being separate of the service provider computer 106, in alternate embodiments, the medical testing processor 180 or the functions that it completes may be part of the service provider computer 106. In those embodiments where the medical testing processor 180 is incorporated into the service provider computer 106, and with regard to the methods described above, the elements describing transmitting or receiving between the service provider computer 106 and the medical testing processor 180 may be internal transmissions within the service provider computer 106 or may be omitted altogether. Further, while the exemplary embodiments described herein disclose certain steps occurring at the service provider computer 106 and/or the medical testing processor 180, in alternative embodiments those steps described with reference to FIGS. 1-4 may alternately be completed at a pharmacy computer 104A, a prescriber computer 104B, or another healthcare provider computer 104 (e.g., a hospital computer, clinic computer, etc.) a claims processor computer 108, a medical testing processor 180, any combination thereof, and/or a combination of those devices along with the service provider computer 106. In those alternate embodiments, certain transmission/receiving steps described above with reference to FIGS. 1-4 may be omitted while others may be added, as understood by one or ordinary skill in the art. The intent being that, in alternate embodiments, any of the devices/computers discussed in FIG. 1 are capable of completing all or any part of the methods described with reference to FIGS. 2A-4.

Various block and/or flow diagrams of systems and methods and/or computer program products according to example embodiments are described above. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments.

These computer-executable program instructions may be loaded onto a special purpose computer or other particular machine, a processor, or other programmable data processing apparatus to produce a particular machine, such that the instructions that execute on the computer, processor, or other programmable data processing apparatus create means for implementing one or more functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the disclosure may provide for a computer program product, that includes a computer usable medium (e.g., transitory or non-transitory) having a computer-readable program code or program instructions embodied therein, said computer-readable program code adapted to be executed to implement one or more functions specified in the flow diagram step or steps. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram step or steps.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

Many modifications and other embodiments of those set forth herein will be apparent having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system, comprising;
at least one memory operable to store computer-executable instructions; and
at least one processor configured to access the at least one memory and execute the computer-executable instructions to:
receive a medical test result for a patient, wherein the medical test result comprises a patient identifier identifying the patient, a medical testing date identifying a date a medical test was administered to the patient, and at least one test result for the medical test administered to the patient;
identify a plurality of potential test result categories for comparison to the at least one test result;
compare the at least one test result to the plurality of potential test result categories;
determine, based at least in part on the comparison, one of the plurality of potential test result categories that the at least one test result is within;
identify a dosage range associated with the determined one of the plurality of potential test result categories that the at least one test result is within; and
store the identified dosage range as a determined dosage range for a medication for the patient;
receive a healthcare claim transaction from a pharmacy computer for a pharmacy, wherein the healthcare claim transaction comprises a medication identifier identifying the medication prescribed to the patient, a dosage level for the medication, the patient identifier, and a date of service;
compare the dosage level to the identified dosage range to determine if the dosage level is within the identified dosage range; and
direct communication of the healthcare claim transaction to a claims processor computer associated with a claims processor for adjudication based at least in part on a determination that the dosage level is within the identified dosage range.

2. The system of claim 1, wherein the at least one processor is further configured to access the at least one memory and execute the computer-executable instructions to:
generate a rejection of the healthcare claim transaction based at least in part on a determination that the dosage level is not within the identified dosage range; and
direct communication of the rejection of the healthcare claim transaction to the pharmacy computer.

3. The system of claim 1, wherein the at least one processor is further configured to access the at least one memory and execute the computer-executable instructions to:
direct communication of the identified dosage range to a prescriber computer for a prescriber of the medication;
receive, from the prescriber computer, a dosage range override response, the dosage range override response comprising an override rationale and an override dosage range; and
updating the stored identified dosage range to equal the override dosage range.

4. The system of claim 1, wherein the at least one processor is further configured to access the at least one memory and execute the computer-executable instructions to:
identify an upper threshold time period;
determine a length of time for which the patient has received the medication;
determine that the length of time for which the patient has received the medication is greater than the upper threshold time period;
compare the at least one test result to a range of test result data indicative of a normal test result;
determine, based on the comparison, that the at least one test result is within the range of test result data indicative of the normal test result; and
set a medical test frequency period for the patient to a least frequent medical testing period for the medication based at least in part on the determination that the length of time for which the patient has received the medication is greater than the upper threshold time period and that the at least one test result is within the range of test result data indicative of the normal test result.

5. A computer-implemented method comprising:
receiving, by a service provider computer comprising at least one processor, a medical test result for a patient, wherein the medical test result comprises a patient identifier identifying the patient, a medical testing date identifying a date a medical test was administered to the patient, and at least one test result for the medical test administered to the patient;
identifying, by the service provider computer, a first test result range and a second test result range for comparison to the at least one test result;
comparing, by the service provider computer, the at least one test result to the first test result range and the second test result range;
determining, by the service provider computer and based at least in part on the comparison, that the at least one test result is within the first test result range;
identifying, by the service provider computer and based at least in part on the determination, a medication dosage range associated with the first test result range; and
setting, by the service provider computer, a determined medication dosage range equal to the identified medication dosage range.

6. The computer-implemented method of claim 5, further comprising determining, by the service provider computer, a medical test frequency period based at least in part on the at least one test result for the patient.

7. The computer-implemented method of claim 6, wherein determining the medical test frequency period comprises:
identifying, by the service provider computer, an upper threshold time period;
determining, by the service provider computer, a length of time for which the patient has received the medication;
comparing, by the service provider computer, the length of time for which the patient has received the medication to the upper threshold time period;
determining, by the service provider computer and based at least in part on the comparison, that the length of time for which the patient has received the medication is greater than the upper threshold time period;
comparing, by the service provider computer, the at least one test result to a range of test result data indicative of a normal test result;
determining, by the service provider computer and based at least in part on the comparison, that the at least one test result is within the range of test result data indicative of the normal test result; and
setting, by the service provider computer, a medical test frequency period for the patient to a least frequent medical testing period for the medication based at least in part on the determination that the length of time for which the patient has received the medication is greater than the upper threshold time period and that the at least one test result is within the range of test result data indicative of the normal test result.

8. The computer implemented method of claim 6, wherein determining the medical test frequency period comprises:
identifying, by the service provider computer, a lower threshold time period;
determining, by the service provider computer, a length of time for which the patient has received the medication;
comparing, by the service provider computer, the length of time the patient has received the medication to the lower threshold time period;
determining, by the service provider computer and based at least in part on the determination that the length of time the patient has received the medication is less than the lower threshold time period; and
setting, by the service provider computer, a medical test frequency period for the patient to a most frequent medical testing period for the medication based at least in part on the determination that the length of time the patient has received the medication is less than the lower threshold time period.

9. The computer-implemented method of claim 5, further comprising:
receiving, by the service provider computer from a pharmacy computer for a pharmacy, a healthcare claim transaction, wherein the healthcare claim transaction comprises a medication identifier identifying the medication prescribed to the patient, a dosage level for the medication, the patient identifier, and a date of service;
comparing, by the service provider computer, the dosage level to the identified dosage range to determine if the dosage level is within the identified dosage range; and
transmitting, by the service provider computer and based at least in part on a determination that the dosage level is within the identified dosage range, the healthcare claim transaction to a claims processor computer associated with a claims processor for adjudication; or
generating, by the service provider computer and based at least in part on a determination that the dosage level is not within the identified dosage range a rejection of the healthcare claim transaction and transmitting the rejected healthcare claim transaction to the pharmacy computer.

10. The computer-implemented method of claim 9, further comprising:
identifying, by the service provider computer and based at least in part on the medication identifier, the medication identified in the healthcare transaction;
receiving, by the service provider computer, a medication history record for the patient;
comparing, by the service provider computer, the medication identifier to the medication history record for the patient to determine if the medication history identifier matches an identifier for medication in the medication history record;
determining, by the service provider computer and based at least in part on the determination that the medication history identifier does not match the identifier for the medication in the medication history record, that this is a first time the patient is prescribed the medication; and
storing, by the service provider computer, a current date as a medication start date for the medication for the patient.

11. The computer-implemented method of claim 5, further comprising:
transmitting, by the service provider computer to a prescriber computer for a prescriber of the medication, the identified dosage range;
receiving, by the service provider computer from the prescriber computer, a dosage range override response, the dosage range override response comprising an override rationale and an override dosage range; and
updating, by the service provider computer, the stored identified dosage range to equal the override dosage range.

12. The computer-implemented method of claim 11, further comprising:
determining, by the service provider computer and based at least in part on the override rationale that the dosage range override response is based on a patient demographic for the patient; and
generating, by the service provider computer, an override check reminder a predetermined time in the future.

13. A system, comprising;
at least one memory operable to store computer-executable instructions; and
at least one processor configured to access the at least one memory and execute the computer-executable instructions to:
receive a medical test result for a patient, wherein the medical test result comprises a patient identifier identifying the patient, a medical testing date identifying a date a medical test was administered to the patient, and at least one test result for the medical test administered to the patient;
identify a first test result range and a second test result range for comparison to the at least one test result;
compare the at least one test result to the first test result range and the second test result range;
determine, based at least in part on the comparison, that the at least one test result is within the first test result range;
identify, based at least in part on the determination, a medication dosage range associated with the first test result range; and
set a determined medication dosage range equal to the identified medication dosage range.

14. The system of claim 13, wherein the at least one processor is further configured to access the at least one memory and execute the computer-executable instructions to: determine a medical test frequency period based at least in part on the at least one test result for the patient.

15. The system of claim 14, wherein the at least one processor is further configured to determine the medical test frequency period by accessing the at least one memory and executing the computer-executable instructions to:
identify an upper threshold time period;
determine a length of time for which the patient has received the medication;
compare the length of time for which the patient has received the medication to the upper threshold time period;
determine, based at least in part on the comparison, that the length of time for which the patient has received the medication is greater than the upper threshold time period;
compare the at least one test result to a range of test result data indicative of a normal test result;
determine, based at least in part on the comparison, that the at least one test result is within the range of test result data indicative of the normal test result; and
set a medical test frequency period for the patient to a least frequent medical testing period for the medication based at least in part on the determination that the length of time for which the patient has received the medication is greater than the upper threshold time period and that the at least one test result is within the range of test result data indicative of the normal test result.

16. The system of claim 14, wherein the at least one processor is further configured to determine the medical test frequency period by accessing the at least one memory and executing the computer-executable instructions to:
identify a lower threshold time period;
determine a length of time the patient has received the medication;
compare the length of time the patient has received the medication to the lower threshold time period;
determine, based at least in part on the determination that the length of time the patient has received the medication is less than the lower threshold time period; and
set a medical test frequency period for the patient to a most frequent medical testing period for the medication based at least in part on the determination that the length of time the patient has received the medication is less than the lower threshold time period.

17. The system of claim 13, wherein the at least one processor is further configured to access the at least one memory and execute the computer-executable instructions to:
receive, from a pharmacy computer for a pharmacy, a healthcare claim transaction, wherein the healthcare claim transaction comprises a medication identifier identifying the medication prescribed to the patient, a dosage level for the medication, the patient identifier, and a date of service;
compare the dosage level to the identified dosage range to determine if the dosage level is within the identified dosage range; and
direct, based at least in part on a determination that the dosage level is within the identified dosage range, communication of the healthcare claim transaction to a claims processor computer associated with a claims processor for adjudication; or
generate, by the service provider computer and based at least in part on a determination that the dosage level is not within the identified dosage range a rejection of the healthcare claim transaction and direct communication of the rejected healthcare claim transaction to the pharmacy computer.

18. The system of claim 17, wherein the at least one processor is further configured to access the at least one memory and execute the computer-executable instructions to:
identify, based at least in part on the medication identifier, the medication identified in the healthcare transaction;
receive a medication history record for the patient;
compare the medication identifier to the medication history record for the patient to determine if the medication history identifier matches an identifier for medication in the medication history record;
determine, based at least in part on the determination that the medication history identifier does not match the identifier for the medication in the medication history record, that this is a first time the patient is prescribed the medication; and
store a current date as a medication start date for the medication for the patient.

19. The system of claim 13, wherein the at least one processor is further configured to access the at least one memory and execute the computer-executable instructions to:
direct, to a prescriber computer for a prescriber of the medication, communication of the identified dosage range;
receive, from the prescriber computer, a dosage range override response, the dosage range override response comprising an override rationale and an override dosage range; and
update the stored identified dosage range to equal the override dosage range.

20. The system of claim 19, wherein the at least one processor is further configured to access the at least one memory and execute the computer-executable instructions to:
determine, based at least in part on the override rationale that the dosage range override response is based on a patient demographic for the patient; and
generate an override check reminder a predetermined time in the future.
